(19) United States
(12) Patent Application Publication
(10) Pub. No.: US 2016/0132979 A1
(43) Pub. Date: May 12, 2016

(54) SYSTEMS AND METHODS FOR PROVIDING AN AUTOMATED TRADEMARK CLEARANCE AND/OR WATCH NOTICE SERVICE

(71) Applicant: TM TKO, LLC, Franklin, TN (US)

(72) Inventors: Matt Schneller, Franklin, TN (US); Alex Durgin, Nashville, TN (US)

(21) Appl. No.: 14/940,076

(22) Filed: Nov. 12, 2015

Related U.S. Application Data
(60) Provisional application No. 62/078,218, filed on Nov. 11, 2014.

(51) Int. Cl. G06Q 50/18; G06Q 10/06

(52) U.S. Cl. CPC G06Q 50/184; G06Q 10/0635

(57) ABSTRACT

A facility for providing a registrability analysis for a user-provided potential trademark is described. The facility receives a proposed trademark and proposed goods and/or services from the user. The facility then applies a series of comparisons and analyses to determine which trademark applications or trademark registrations in a given trademark registry may pose registration risks, weights those risks according to a relative weighting model, and obtains an overall risk analysis for the proposed mark and goods and/or services. The facility reports the risk analysis and relevant results for the proposed mark and goods and/or services.

### RELATED APPLICATIONS

This application claims the benefit of U.S. Provisional Patent Application No. 62/078,218, titled SYSTEMS AND METHODS FOR PROVIDING AN AUTOMATED TRADEMARK CLEARANCE AND/OR WATCH NOTICE SERVICE, filed on Nov. 11, 2014, which is herein incorporated by reference in its entirety.

### BACKGROUND

Before adopting a trademark, many businesses like to know whether their proposed mark is likely to be registrable in trademark offices where they do business. Businesses can use publicly available databases to do their own searches, or hire an attorney or other professional to provide a search and/or search analysis.

The typical search relies on a variety of factors, but particularly the similarity between the proposed mark and the marks in prior trademark applications and registrations (mark similarity), and the similarity of the goods and/or services (goods or services similarity) for which the proposed mark will be used to the goods and/or services in prior trademark applications and registrations for similar marks.

### BRIEF DESCRIPTION OF THE DRAWINGS

FIG. 1 is a block diagram illustrating the processing of a classify component in accordance with some embodiments of the disclosed technology.

FIG. 2 is a block diagram illustrating the processing of an identify applications component of the facility in accordance with some embodiments of the disclosed technology.

FIG. 3 is a block diagram illustrating the processing of an identify similar marks component of the facility in accordance with some embodiments of the disclosed technology, based on a user-entered mark and dynamically generated “tokens” thereof.

FIG. 4 is a block diagram showing the processing of an identifying and applying weights for each good or service in each application or registration identified by the process shown in FIG. 3, based on each user-entered good or service in accordance with some embodiments of the disclosed technology.

FIG. 5 is a block diagram illustrating some of the components that may be incorporated in at least some of the computer systems and other devices on which the system operates and with which the system interacts in some examples.

FIG. 6 is a sample graph plotting prior applications and registrations against two confusion risk factors (mark similarity and goods-services similarity).

### DETAILED DESCRIPTION

The inventors have recognized that the conventional approaches to performing trademark registrability searches have significant disadvantages. For example, searches can take days to complete, can be expensive, and the quality of results can vary based on the personal experience, judgments, and sophistication of the searcher.

The inventors have recognized that a consistent registrability search tool that provides both relevant data and analysis would have significant utility.

A software facility for automatically identifying relevant search data and for performing an automated registrability analysis in a given jurisdiction or jurisdictions based on user-submitted data including, for example, a mark and an indication of goods or services is described. For example, a user may submit the mark “Sanchez,” to be used in connection with musical instruments and apparel.

### Preparing the Database

In some embodiments, the facility imports trademark data on regular intervals (daily, weekly, monthly) or dynamic intervals (as a trademark office or other provider of trademark data posts additional data or otherwise makes additional data available). The facility may further enhance and analyze the extracted data by, for example, normalizing data formats, stemming data, recognizing business rules (e.g. identifying only active classes and active goods and services out of all classes and all goods and services for a given application or registration, identifying application and registration records as “live” or “dead,” and tracking current and historical ownership data), deciding (using machine-learning techniques from user-defined examples) which assignments are present transfers of title and updating ownership data accordingly, and more.

In some embodiments, the facility includes a specialized, purpose-built database derived from trademark office records (e.g. United States Patent & Trademark Office records, Europe's Office for Harmonization in the Internal Market records). In trademark records, most goods and services are separated by semicolons. In some embodiments, goods and services strings that are separated by semicolons only, are broken down into separate strings. In some embodiments, the facility also breaks down lists (separated by semicolons, by commas, or by conjunctions) by parsing or “breaking down” each into separate lists, as though originally separated by semicolons, by analyzing the parts of speech of each term or terms (e.g., word or words, phrase or phrases) in the list. The facility separates and divides individual good or service strings (delimited by, for example, semicolons or as divided as described in the previous sentence) in each active, use-based registration, and identifies how many times each individual good or service is paired with any other good or service. The facility's purpose-built database combines all active use-based registrations for the same mark (determined by, for example, the literal element of the mark, what kind of mark the mark in the application is coded as (e.g., word mark, design mark, etc.), the design description, the design code, and/or a comparison of the visual elements of the mark) owned by the same owner. For example, General Motors may own multiple trademark registrations for the identical “GM” word mark. In the facility's purpose-built database, the goods and services covered by each of these registrations would be combined into a single record to better represent the full scope of goods and services provided under that mark. This provides a more accurate picture of related goods and services because it can include data from trademark owners who own multiple registrations for the same mark, data from trademarks issued over time, data from trademarks registered as multiple single class registrations instead of one multi-class registration, and so on rather than relying upon goods/services comparison data on a registration-by-registration basis. The facility can also “tokenize” any or all marks in applications or registrations using three steps. First, the facility identifies component features of the mark (words, matches of string patterns associated with temporal indicators, numeric representations, emoticons, domain names, other patterns of characters and special characters, etc.) by means of comparisons with of string patterns or existing corpuses of data. For example, the facility could identify “:-)” as an emoticon feature from an emoticon corpus (e.g., a list or collection of emoticons), and add an appropriate token. Second, based on these identifications, the facility may dynamically create and identify new components (e.g. numeric, numerals, Roman numerals, translations or other alias creations (of digit formats, of languages, of synonyms or related words, etc.), splitting and joining strings across special characters or other patterns, etc.) based on pre-existing rules or algorithms. For example, the facility could identify the string “123” as a number, and add tokens for “123,” “100, “1,” “2”, and “3.” As another example, the facility may split strings based on a list or collection of delimiters (e.g., ‘−’, ‘ ’, “/”) or changes in characters in the string (e.g., CamelCase). Third, the facility splits a compound component into its likely component parts (e.g. splitting joined words, like “Pizzamatch” into “Pizza” and “Match”) by using a set corpus or corpuses (e.g. marks in prior trademark applications and registrations, in a dictionary, etc.) and frequency data from that corpus or corpuses to create components. For example, the facility would identify possible splits for “BestTopics” by using word lists, and select the best possible fit (“Best” and “Topics”) of those possible splits by using word corpus frequency data. The components are saved and indexed as “tokens.” The facility also identifies the “stem” (or “root”) of each token in the mark, using several alternative algorithms, and are also saved and indexed as tokens. For example, the facility may parse the mark “11BestTopics” into three separate components: “11,” “Best,” and “Topics.” In this example, the facility identifies the number 11 as a feature (step 1 above) because it is a numeric representation (string or pattern match). The facility splits “11” from “Best” and “Best” from “Topics” (step 3) after identifying possible splits for each using a word list and selecting the most-likely split using a word frequency table. The facility also dynamically creates tokens for each of these components based on the splits. In this example, the facility may dynamically create tokens such as “11,” “10,” “1,” “Eleven,” “XI,” “Best,” “Topics,” and “Topic” (step 2).

### Searching for Similar Marks

In some embodiments, the facility analyzes a user-entered mark (either directly entered or by providing a serial number of a prior application or registration) by, for example, performing a tokenization process, such as the process described above, to the user-entered mark (i.e., identifying component features, dynamically creating and identifying new components, and splitting compound components).

In some embodiments, the facility identifies weights for each term and/or tokens in a mark. For example, a term and/or token that is part of a mark is assigned a lower weight or weights (user-defined or dynamically defined) where the term has some or all of the following features: (a) it appears in user-entered description of goods or services, (b) it appears in goods or services descriptions of prior registrations and/or prior pending applications in the same class as the user-entered description of goods or services, (c) it is disclaimed in prior registrations or prior pending applications in the same class as the user-entered description of goods or services, (d) is in prior registrations on a non-primary register, such as the Supplemental Register of trademarks maintained by the United States Patent and Trademark Office, in the same class as the user-entered description of goods or services, and/or (e) it appears in a number of prior registrations owned by a number of different owners in the same class as the user-entered description of goods or services.

In some embodiments, the facility analyzes the user-entered mark and the tokens derived from analysis of the user-entered mark, and searches for and provides dynamically assigned weights for one or more search strategies, including, for example, searching for: identical marks, marks sharing the same stems, marks sharing the same “tokens,” marks sharing the same stemmed tokens, marks containing phonetically identical tokens, marks containing phonetically similar tokens, marks or tokens with similar letters, marks or tokens with similar meaning, and marks or tokens with similar meanings in another language, marks with similar “edit distance” (e.g., 1 character or 2 character differences), marks or tokens with common strings (e.g., at the beginning of a term, at the end of a term, or anywhere in a term or mark), marks or tokens with similar n-grams, marks with similar design codes, marks with similar design descriptions, marks with visual similarities, etc. Prior applications or registrations with marks that share similar tokens weighted more heavily (as described in further detail below), and prior applications or registrations that share multiple more-similar terms, are assigned higher overall similarity scores than marks that share only terms or tokens that are weighted more weakly (as described in further detail below) or marks or tokens that share fewer more-similar terms. Marks or tokens that “match” on multiple lower-weighted strategies (e.g. phonetic similarity (based on a phonetic algorithm, such as the Double Metaphone algorithm) and one-or-two character “edit distance”) may be assigned a weight greater than either of those lower-weighted strategies individually. The dynamically assigned weight may, for example, set the scoring “ceiling” (e.g., 1.0, 10, 100, 40) for a distinctive token, and apply reductions based on the search strategy that matched that term.

In some embodiments, the facility may score the prior application or registration based on the highest score of any token match.

In some embodiments, the facility may score the prior application or registration based on its total score of the highest scores of all token matches divided by the total possible score for matching on all tokens (e.g. if the prior application or registration's tokens match on two of three tokens of the user entered mark, the prior application or registration would receive a score equal to the dynamic weights of each token (reduced by the search “quality” weight, if applicable) divided by the total possible score of the user-entered mark.

In some embodiments, the facility may combine the scoring methods, such as those described in ¶ [0017] and ¶ [0018], using a simple ratio or attributing weights/scaling coefficients to each score and calculating a sum of the weighted scores.

In some embodiments, the facility may provide an additional weight for a prior application or registration where the mark matches on multiple tokens in the user-entered mark. This provides adequate weighting for, e.g., a slogan that shares many tokens in common with a mark in a prior application or registration.

### Searching for Similar Goods and Services

### Identification and Analysis of Class Data

In some embodiments, the facility identifies the probable international class for the goods or services entered by the user (or takes the classification data from a user-identified existing serial number, if applicable) based on, for example, the class in which those goods or services were contained in recently issued (e.g. in the past year, five years, seven year, and so on) registrations. For example, a user could select an already-pending application for a registration analysis (and the disclosed system could obtain mark and goods/services data from that record), or the user could manually enter information about a mark that has not been filed yet.

### Use of Class Data to Identify and Classify Similar Prior Applications or Registrations

In some embodiments, the facility identifies the probable international class(es) for the goods or services entered by the user (or takes the classification data from a user-identified existing serial number, if applicable) and any coordinated classes (e.g., “coordinated classes” related to that class or classes as defined by the United States Patent and Trademark Office or any other trademark office), and further identifies prior trademark applications or trademark registrations that contain those classes and assigns each prior trademark application or trademark registration a given minimum weight (e.g., 0.2) for being in the primary class (i.e., the best fit for the user-entered good or service) or coordinated class. For example, for the good “tires” the facility may identify all international classes that include the words “tire” or “tires,” select the most common international class(es) as the “probable” or “primary” class(es), and identify coordinated classes associated with that probable or primary class(es).

In some embodiments, the facility identifies the probable international class(es) for the goods or services entered by the user (or takes the classification data from a user-identified existing serial number, if applicable) and the “coordinated classes” related to that class, and further identifies any prior trademark applications or trademark registrations that contain any active goods and/or services in that class (or classes) and assigns each prior trademark application or trademark registration a given minimum weight (e.g., 0.3) for being in the primary class or coordinated class.

In some embodiments, the facility identifies (a) the probable international class(es) for the goods or services entered by the user (or takes the classification data from a user-identified existing serial number, if applicable), (b) any prior trademark applications or trademark registrations that contain that class (or classes) or coordinated classes and assigns each prior trademark application or trademark registration a given minimum weight for being in the primary class or coordinated class, and (c) any prior trademark applications or trademark registrations that contain related classes (as pre-set or as determined dynamically as described in the “goods and services identification and analysis” section below) and assigns each prior trademark application or trademark registration a minimum weight based on, for example, predetermined weights assigned to each or dynamically based on the degree of relatedness.

In some embodiments, the facility identifies (a) the probable international class(es) for the goods or services entered by the user (or takes the classification data from a user-identified existing serial number, if applicable), (b) any prior trademark applications or trademark registrations that contain any active goods and/or services in that class (or classes) or coordinated classes and assigns each prior trademark application or trademark registration a given minimum weight for being in the primary class or coordinated class, and (c) any prior trademark applications or trademark registrations that contain any active goods and/or services in related classes (as pre-set or as determined dynamically as described in the “goods and services identification and analysis” section below) and assigns each prior trademark application or trademark registration a minimum weight based on, for example, predetermined weights assigned to each or dynamically based on the degree of relatedness.

In some embodiments, the facility identifies (a) the probable international class(es) for the goods or services entered by the user (or takes the classification data from a user-identified existing serial number, if applicable), (b) any prior trademark applications or trademark registrations that contain that class (or classes) or coordinated classes and assigns each prior trademark application or trademark registration a given minimum weight for being in the primary class or coordinated class, and (c) any prior trademark applications or trademark registrations that contain any active goods and/or services in related classes (as pre-set or as determined dynamically as described in the “goods and services identification and analysis” section below) and assigns each prior trademark application or trademark registration a minimum weight based on, for example, predetermined weights assigned to each or dynamically based on the degree of relatedness.

In some embodiments, the facility identifies (a) the probable international class(es) for the goods or services entered by the user (or takes the classification data from a user-identified existing serial number, if applicable), (b) identifies any prior trademark applications or trademark registrations that contain any active goods and/or services in that class (or classes) or coordinated classes and assigns each prior trademark application or trademark registration a given minimum weight for being in the primary class or coordinated class, and (c) any prior trademark applications or trademark registrations that contain any active goods and/or services in related classes (as pre-set or as determined dynamically as described in the “goods and services identification and analysis” section below) and assigns each prior trademark application or trademark registration a minimum weight based on, for example, predetermined weights assigned to each or dynamically based on the degree of relatedness.

In some embodiments, the facility identifies (a) the probable international class(es) for the goods or services entered by the user (or takes the classification data from a user-identified existing serial number, if applicable), (b) any prior trademark applications or trademark registrations that contain any active goods and/or services in that class (or classes) or coordinated classes and assigns each prior trademark application or trademark registration a given minimum weight for being in the primary class or coordinated class, and (c) any prior trademark applications or trademark registrations that contain any active goods and/or services in related classes (as pre-set or as determined dynamically as described in the “goods and services identification and analysis” section below) and assigns each prior trademark application or trademark registration a minimum weight based on, for example, predetermined weights assigned to each or dynamically based on the degree of relatedness).

In some embodiments, the facility identifies (a) the probable international class(es) for the goods or services entered by the user (or takes the classification data from a user-identified existing serial number, if applicable), (b) identifies any prior trademark applications or trademark registrations that contain any active goods and/or services in that class (or classes) or coordinated classes and assigns each prior trademark application or trademark registration a given minimum weight for being in the primary class or coordinated class, (c) any prior trademark applications or trademark registrations that contain any active goods and/or services in related classes (as pre-set or as determined dynamically as described in the “goods and services identification and analysis” section below) and assigns each prior trademark application or trademark registration a lower minimum weight based on, for example, predetermined weights assigned to each class or dynamically based on the degree of relatedness.

### Identification and Analysis of Goods and Services Data to Determine Similarity to User-Identified Goods and Services

In some embodiments, the facility relies on the ratio of overlap in each goods and services string compared to the user-entered goods or services. For example, how many times “tortilla chips” (entered by the user) and “salsa” appear in active, use-based registrations for the same mark owned by the same owner, divided by how many times “tortilla chips” appears in active, use-based registrations overall.

In some embodiments, the facility relies on the ratio of overlap in each goods and services string compared to the goods or services that the database identifies as related to the user-entered goods or services. For example, the facility can calculate how many times “tortilla chips” (entered by the user) and “salsa” appear in active, use-based registrations for the same mark owned by the same owner, divided by how many times “salsa” appears in active, use-based registrations overall. This ratio can be the basis of a similarity score between the user-entered goods-and-services string (“tortilla chips” in this example) and “salsa.” This ratio may be further refined, e.g. by taking into account class and/or coordinated class data. For example, the effective score for a string match for the goods/services string “tortilla chips” may be reduced if “tortilla chips” is part of a goods/services containing a similar string, such as, “retail services in the field of tortilla chips” that is not in the primary international class.

In some embodiments, the facility relies on the ratio of overlap in each goods and services string compared to the user-entered goods or services, with additional weighting based on the ratio of overlap in each goods and services string compared to the goods or services that the database identifies as related to the user-entered goods or services. For example, how many times “tortilla chips” (entered by the user) and “salsa” both appear in active, use-based registrations for the same mark owned by the same owner, divided by how many times “tortilla chips” appears in active, use-based registrations overall, receives the primary weight (usually higher). For example, the following simple chart demonstrates the type of overlap of various goods and services:

| | | | Brewpub | Restaurant | | | |
|---|---|---|---|---|---|---|---|
| | Beer | Ale | services | services | Chips | Salsa | Tacos |
| Beer | 2 | 2 | 1 | 1 | 0 | 0 | 0 |
| Ale | 2 | 2 | 1 | 1 | 0 | 0 | 0 |
| Brewpub | 1 | 1 | 1 | 1 | 0 | 0 | 0 |
| services | | | | | | | |
| Restaurant | 1 | 1 | 1 | 3 | 1 | 1 | 1 |
| services | | | | | | | |
| Chips | 0 | 0 | 0 | 1 | 2 | 2 | 1 |
| Salsa | 0 | 0 | 0 | 1 | 2 | 2 | 1 |
| Tacos | 0 | 0 | 0 | 1 | 1 | 1 | 1 |

In this example, the chart shows that there are two entries in the database containing “ale” and “beer” and two entries in the database containing “salsa” and “chips.”

A supplemental, dynamic weight (e.g., the weight given depending on how common the non-user entered good or service is) based on the ratio of overlap in each goods and services string compared to the goods or services that the database identifies as related to the user-entered goods or services. Paragraph [0036] below provides additional details and examples.

In some embodiments, the facility identifies trademark applications or trademark registrations that contain goods and/or services that are identical or related to (as determined by the steps above), and applies weights (as described above, for goods and services and/or for classes) to goods or services in the trademark applications or trademark registrations. Trademark applications or trademark registrations are given an overall goods and service “score” equal to the weight assigned to the most-similar product or service in that trademark application or trademark registration.

In some embodiments, the facility assigns a maximum similarity score where the good or service searched for is identical to the user-entered good or service word or phrase and is classified in the same class, or if the good or service word or phrase is in the same class as the user-entered good or service word or phrase (as determined above) and contains the user-entered good or service word or phrase.

In some embodiments, if a maximum similarity score has not been assigned, then the similarity score is assigned a figure equal to the highest number generated by any calculation of the same good or service string, determined by multiplying the similarity score for the good or service identified by the facility by a weight ranging from, for example, 0-1 based on the commonality of source good or service word or phrase that was in the same class. For example, if the most common good or service word or phrase had 100 instances (i.e. 100 appearances in “registration” records in the custom database described in paragraph [0013]) and a first one of the two other qualifying good or service words or phrases had 50 instances while the second other qualifying good or service word or phrase had 5 instances, the weights applied to the most common good or service word or phrase would be 100/100=1, the weight applied to the first one of the two other qualifying good or service word or phrases would be 50/100=0.5, and the weight applied to the second one of the two other qualifying good or service word or phrases would be 5/100=0.05. If the same good or service is identified in lists generated by both the good or service word or phrase with a given similarity score and more total instances, and a second good or service word or phrase with the same similarity score but fewer instances, it is given the higher of the two weights. For example, the user enters “tortilla chips” and the facility determines that “tortilla chips” is a goods string that matches a goods string that is in the goods/services database, and “tortilla chips” alone has the highest number of instances or matches (e.g. 100 instances) of any goods/services string that contains “tortilla chips”. “Tortilla chips” receives a maximum similarity score, e.g. 1, for having the highest number of instances. Of the 100 instances, “salsa” is present in 20 instances, so has a weight of 0.2*(max score*1 [full weight for having the most instances]). The database also contains “blue corn tortilla chips” (e.g. 5 instances). “Blue corn tortilla chips” contains “tortilla chips” and is in the same international class as “tortilla chips,” and so receives a maximum similarity score. In this example, each registration containing “blue corn tortilla chips” also contained “salsa,” resulting in a weight of 1*(max score*(5 [no. of instances for “blue corn tortilla chips”]/100 [no. of instances for “tortilla chips”]) (i.e., 0.05*max score). The score for salsa is then 0.2 (i.e., the greater of 0.2 (the score derived from “tortilla chips”) and 0.05 (the score derived from “blue corn tortilla chips”)). This model prevents smaller data sets from skewing the instances to make goods/services appear more or less related than they actually are.

In some embodiments, a further weight is assigned (either pre-defined or dynamically determined) if a third-party application or registration contains the same international class as the goods and services that the user entered, and/or the good or service word or phrase is de-weighted if the good or service word or phrase is not in the same international class (or a coordinated class thereof) as the user-entered good or service word or phrase. For example, if the user enters “tortilla chips” and the facility generates a similarity score for “salsa” as described above, and “salsa” is in the same international class as “tortilla chips” (as determined using the process described above), the similarity score would be increased by a set amount (e.g. by adding 0.1 to the amount) (the set amount may be the same for all classes or vary by class, or different similarity weights may be pre-assigned across classes) or by a dynamically determined amount. For example, if the user entered “salsa,” and one result was “nuts,” a hit for “nuts and bolts” in a different class (i.e., a class that is not the primary international class for “salsa” (foods vs. metals)) the result for “nuts and bolts” would be de-weighted.

In some embodiments, if more than one user-entered goods or services has a similarity score for the same good or services, e.g. if the user enters “tortilla chips” and “potato chips,” and there is a similarity score for “salsa” for both (e.g. 0.4 for “tortilla chips” and “salsa” and 0.2 for “tortilla chips” and “potato chips”), then a third-party application or registration containing “salsa” is assigned the higher of the two scores (e.g. a prior application or registration containing “salsa” would receive a score of 0.4, the higher of 0.4 and 0.2). At display time, these weights can be dynamically modified—if the user wants to see results applying only to “potato chips,” the weight of the third party mark could be changed to 0.2 (since “tortilla chips” are no longer being taken into account, the 0.4 weight is dropped in favor of the next-highest weight, 0.2).

In some embodiments, if an application or registration has more than one good or service with similarity scores to one or more goods entered by the user, that application or registration record is assigned a similarity score equal to the highest similarity score of any good or service. For example, if the user entered “tortilla chips” and a prior registration contained both “salsa” (with, say, a 0.4 similarity score) and “potato chips” (with, say, a 0.3 similarity score), the prior application or registration will be assigned a similarity score of 0.4 (the higher of 0.4 and 0.3). If the user entered multiple goods or services to search, the weights can be dynamically modified as described in the preceding paragraph.

In some embodiments, similar goods or services are identified using other techniques. For goods and services where a common good or service word or phrase is provided with more specificity by the following good or service word or phrases, like “software” or “application” or “program,” the facility identifies the initial good or service word or phrase (e.g. “software”) (in some embodiments, also including international classification overlap or similarity) and then associated word(s) or phrase(s) (e.g. “educational”) that modify the initial good or service word or phrase, and identifies other trademark applications or trademark registrations with the same or similar good or service word or phrases paired with a pre-defined list of “anchor” words or phrases (like “software” for software-related goods or services or “retail” and related words or phrases for retail-related services) in pre-defined “anchor” classes. In some embodiments, a further weight is assigned (either pre-defined or dynamically determined) if a third-party application or registration contains the same international class as the goods and services that the user entered. In some embodiments, the facility automatically suggests searching the additional good or service word or phrases entered by the user. For example, if the user selects a “retail” search and selects “peas” as the goods/services, the facility may suggest searching for “peas” as a standalone good (i.e., not in association within any particular field of use, like retail services) in addition to searching for “peas”-related retail services.

Selecting Applications and Registrations with Both Similar Marks and Similar Goods

In some embodiments, the facility is configured to identify applications that include both similar marks and similar goods. To do so, the facility first selects applications and registrations previously identified using the techniques described above for selecting similar marks. Next, the facility selects a subset of these applications and registrations by limiting the results to just those that contain similar goods and services strings and/or identical or coordinated international classes, as described below. For example, a search for the mark “GripSure” for “tires” identifies “tires” as in International Class 12, identifies all coordinated classes related to International Class 12, and identifies, for example, the 1,000 most-related goods or services strings (and additional keywords) related to “tires.” Prior applications or registrations identified above as similar to “GripSure” but containing neither International Class 12, a coordinated class to International Class 12, nor one of these related goods or services strings are scored as “0” goods-services similarity (i.e. are dropped).

In some embodiments, the facility limits the results to those containing similar goods and services strings and/or identical or coordinated international classes by conducting an n-gram search using the list of related goods or services identified using the techniques described above (preprocessed into an n-gram format) and conducts a battery of searches on the applications and registrations identified as in any way similar, as described above.

The facility selects the “best” match of n-grams, based on the ratio of matching n-grams to the number of available n-grams. Qualification is based on a dynamically assigned scale. For example, assume there is a prior registration for “Grippy” for a variety of goods, one of which is “lug nuts for vehicle wheels”. When this good is also identified as being similar, as described above, it may be qualified as the “best” match (i.e. highest scoring for goods-services similarity). Both the similar good and the good available in the prior registration present the same set of n-grams: “lug nuts,” “nuts for,” “for vehicle”, and “vehicle wheels.” This would qualify as a match with the ratio of like n-grams being one-for-one.

In some embodiments, the facility retains only applications and registrations that either (1) have any related goods or services based on the n-gram matching or (2) that contain an identical international class or classes or a coordinated international class or classes.

The most-similar goods and services n-gram selected as described in ¶ [0043] is identified and tracked, and used, for instance, to select and highlight the most-related goods or services in the table showing the search results and mouse-overs for charts providing analysis of those results. In the example above, the goods “lug nuts for wheels” can be tracked for (1) highlighting in the table of search results and/or (2) display as the most relevant goods in the mouse-over of the point signifying this registration in the plot (e.g., scatterplot).

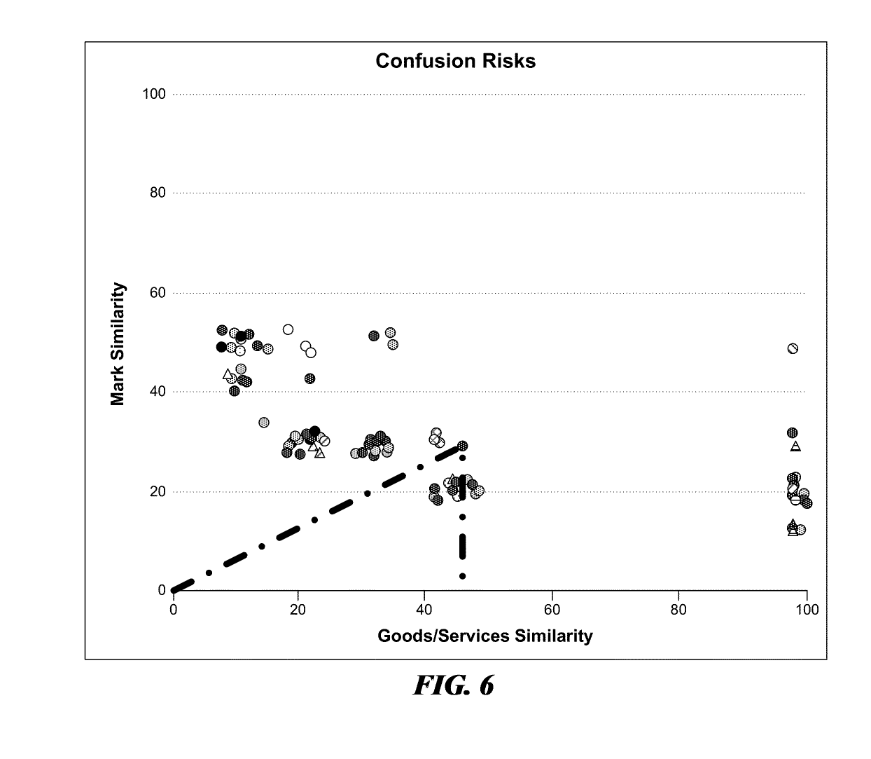

The facility then calculates the overall similarity scores for each application or registration that remains in the result set by combining the mark-similarity and goods/services similarity scores. For example, one way to calculate overall similarity is to take the area of a triangle formed by a drawing line from the origin of a graph to the point of a mark identifying a prior application or registration and a line from that point to the x-axis (using the 0-1 mark similarity score as the y-axis and the 0-1 goods/services similarity score as the x-axis) or by taking a modified area of that triangle (e.g. using the 0-1 mark similarity score as the y-axis, increasing or multiplying that score by a pre-defined or dynamically determined factor and the 0-1 goods/services similarity score as the x-axis). The area of the triangle is a way to combine the two risk factors and approximate the total potential registration “risk” (combined mark similarity and goods-services similarity) posed by the prior application or registration. A sample graph containing many such points and demonstrating a sample triangle for one of those points is shown in FIG. 6.

The facility then provides a pre-selected or dynamically determined number of results (e.g. 5 or 100 or etc.) to the display facility, prioritized by the ranking method in preceding paragraph.

### Identifying Common-Law Results

The facility can use the analysis of mark tokens and goods and services similarity above to identify similar mark in contexts other than a trademark registry.

In some embodiments, the facility provides the user-entered mark and its tokens (as identified above) and the highest-similarity goods or services (as identified above) to a search engine API, searching for the mark and the goods or services.

In some embodiments, the facility may perform specialized searches of particular sites based on the content of the user-selected goods or services. For example, the facility may search within National Institutes of Health websites (for searches for pharmaceuticals or medical devices), in app stores (for searches for software), in alcoholic beverage websites (for searches for alcoholic beverages), etc.

In some embodiments, the facility may search for business names in business name registration databases and in business name directories, in social network identifiers or pages, in domain name registration information directories, etc.

### Displaying Results

In some embodiments, the analysis results are displayed in a chart and/or a table(s). Chart displays and table(s) displays are common in the prior art. A unique feature of this chart will be the ability to toggle to identify just the most similar goods or services (either showing them alone or showing all goods and services and highlighting the most similar in bold, italics, or other different text.

In some embodiments, the strength of the mark and its component parts are shown in a graph, e.g. a bar graph. In some embodiments, users can obtain (e.g. by moving the mouse over a graph line) additional details about why that weight was assigned.

In some embodiments, the prior applications and registrations identified by the search are displayed in a scatterplot. The facility first ranks all the goods/services similarity scores and mark similarity scores generated as described above. The facility then prunes (e.g., does not display) any results that fall below certain pre-determined or dynamically assigned minimum or threshold levels (e.g. marks with very low goods/services similarity scores and with very low mark similarity scores) or below a certain number of marks. The remaining marks plotted with the similarity of marks on the y axis and the similarity of goods/services scores on the x axis (or vice versa). In some embodiments, marks meeting certain conditions are retained, regardless of whether other criteria are met. For example, marks that a user has pre-designated as relevant to the search may be retained and included in the display even if they are relativity dissimilar compared to other marks. For an alternative example, certain marks that are highly similar or identical to the searched-for mark, but contain only minimally related goods or services, may be retained.

In some embodiments, the search result scatterplot will have color bands (e.g. light red, dark red) to identify various risk levels.

In some embodiments, the marks identified in the chart display information about their ownership. For example, owners of any one trademark application or trademark registration could show up in black. Owners of two or more trademark applications or trademark registrations could be displayed in other colors, with one color per owner (either for all owners, or up to a set number of colors).

In some embodiments, the marks identified in the chart display information about their current status. For example:

Circle: registered mark
Darker or shaded circle: Section 15 (or Section 8&15) filed and accepted
Circle: registered but no Section 15 or 8&15 filed yet

Triangle: pending application or recently abandoned and revivable

In some embodiments, the user will be able to enter a name (personal or business entity) and toggle so that results for that entity are not shown in the chart (or are the only results shown on the chart), or so that certain results are highlighted. This will allow users to, for example, only view marks not owned by the user (or the user's client) to more clearly view only third-party marks, or to focus only on the marks owned by one third-party entity or entities (e.g. major competitors). In some embodiments, the facility provides more detailed information in response to various user interactions with the displayed data, such as clicking on the data, performing a mouse-over on the displayed data (e.g. the mark, the owner, the status, the most similar goods or services), and so on.

In some embodiments, the full details for relevant applications or registrations are displayed in a table, organized by score (as described above).

In some embodiments, the common-law results received from the search engine API, and any specialized additional business-area or business-name searches, as described above, are also provided in a table or set of tables.

The facility described above can be adapted to a “watch notice” service. A watch notice service informs a user when an application for a new mark that meets certain criteria is filed (i.e. by performing a search of new applications, newly published applications, and/or applications with any status changes). As one example, the service could inform a user when an application is filed by a particular applicant. As another example, the service could inform a user as to a change of status of a user-identified application. Furthermore, the service could inform a user when an application is filed that shares some similarities with the user's mark(s) (or with the user's application(s) or registration(s)). In the latter example, the watch service is essentially a new trademark search performed each time new trademark data is entered into the facility. If there are any non-pruned results, they can be reported to the user.

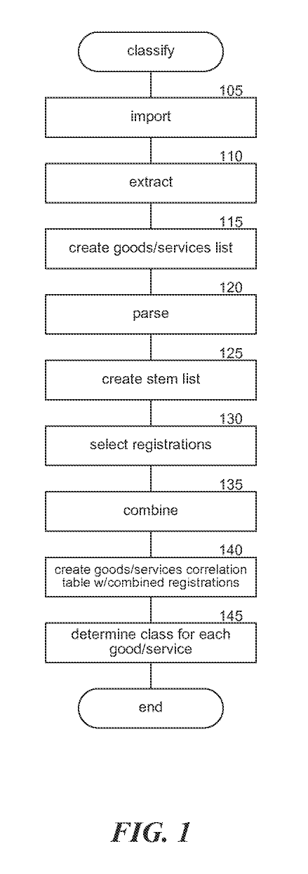

FIG. 1 is a block diagram illustrating the processing of a classify component in accordance with some embodiments of the disclosed technology. The classify component is invoked by the facility to classify marks collected from a mark registry or registrar, such as the United States Patent and Trademark Office (“USPTO”), the Office for Harmonization in the Internal Market (“OHIM”), and so on. In block 105 the component imports trademark data, such as a backfile or database or database update downloaded from the USPTO, the OHIM, or any other entity providing trademark records. In some cases, the component may periodically (e.g., once per hour, once per day, once per week) or as new data is provided by an entity providing trademark records, and import records to supplement the trademark data with new mark data. In block 110, the component extracts, indexes, and stores field data from the collected trademark data. For example, the facility may employ the techniques described in ¶ [0012] to extract, index, and/or store the field data. The component may further enhance and analyze the extracted data by, for example, normalizing data formats, creating “tokens,” stemming data, recognizing business rules (e.g. identifying only active classes and active goods and services out of all classes and all goods and services for a given application or registration, identifying application and registration records as “live” or “dead,” and tracking current and historical ownership data), deciding (using machine-learning techniques from user-defined examples) which assignments are present transfers of title and updating ownership data accordingly, and more. In block 115, after extraction and analyzing are complete, the component creates a number of goods and services lists comprised of, e.g., the goods and services for any application or registration, the active goods and services for any application or registration, and the registered goods and services for any active registration. Most trademark registrations or applications separate different goods or services with semicolons. Not all do, however—some lists are separated by commas or by conjunctions like “and.” In block 120, the component parses the custom goods and services list to separate elements in the list in order to identify each separate good or service, and provide larger and more accurate data sets (e.g., using the techniques described in ¶ [0013]). For example, breaking down “tortilla chips, salsa, and hot sauce” into “tortilla chips; salsa; hot sauce” more accurately identifies these as separate goods, increasing the amount of data for each good individually and providing more accurate correlations overall. For example, each time a delimiter, such as a comma, or a conjunction is encountered in the extracted field data, the component can invoke a part-of-speech tagger, such as the Apache OpenNLP, the Stanford Log-linear Part-Of-Speech Tagger, and/or the Northwestern MorphAdorner, to determine whether the proceeding word or words comprise a list of adjectives, nouns, etc. If the word or words are adjectives (or mostly adjectives), then the component maintains the word or words as a single element. If the word or words are nouns (or mostly nouns), then the component can separate the word or words into single elements in the list, as shown above (the adjective “tortilla” modifies the noun “chips,” “salsa” is a noun,” and the adjective “hot” modifies the noun “sauce”). In block 125, the component creates a separate stemmed words or phrases list (e.g., a stem list, a phrase list) for each individual element identified during the parsing step. In block 130, the component selects all use-based (e.g., 1a) active registrations. In block 135, the component combines all registrations for the same mark (e.g., same literal element, same owner, same mark description, same design codes, and/or visual similarities) by, for example, compressing multiple registrations into a single “meta-registration.” In block 140, the component creates table(s) indicating how frequently each good or service is part of the same registration (as combined) as each other good or service. For example, the facility may employ the techniques described in ¶¶[0030]-[0040] to create the tables.

| | | | Brewpub | Restaurant | | | |
|---|---|---|---|---|---|---|---|
| | Beer | Ale | Services | Services | Chips | Salsa | Tacos |
| Beer | 2 | 2 | 1 | 1 | 0 | 0 | 0 |
| Ale | 2 | 2 | 1 | 1 | 0 | 0 | 0 |
| Brewpub | 1 | 1 | 1 | 1 | 0 | 0 | 0 |
| services | | | | | | | |
| Restaurant | 1 | 1 | 1 | 3 | 1 | 1 | 1 |
| services | | | | | | | |
| Chips | 0 | 0 | 0 | 1 | 2 | 2 | 1 |
| Salsa | 0 | 0 | 0 | 1 | 2 | 2 | 1 |
| Tacos | 0 | 0 | 0 | 1 | 1 | 1 | 1 |

In block 145, the component determines a class of each good or service based on the class in which that good or service is most commonly classified in recent registrations (e.g., registrations issued in the last day, week, month, year, 5 years, and so on).

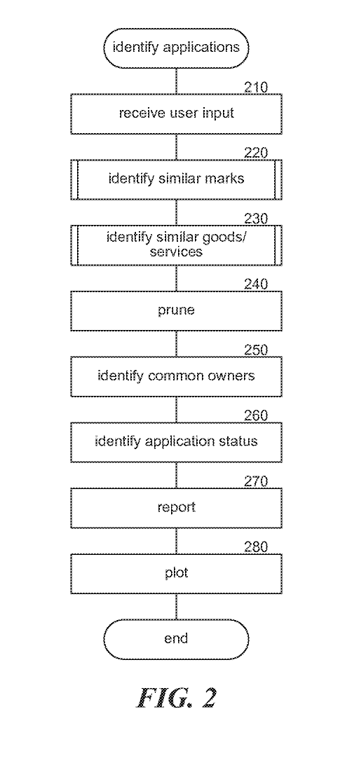

FIG. 2 is a block diagram illustrating the processing of an identify applications component of the facility in accordance with some embodiments of the disclosed technology. In block 210, the component identifies the mark and goods/services for which the mark will be used, based on, for example, receiving an indication of marks and/goods/services from a user, receiving from a user a selection from a list derived from the goods/services list, and/or receiving an indication of a pending application. In block 220, which may be used more than once, the component identifies similar marks. In block 230, the component identifies and weights similar classes, goods and/or services. In block 240, the component “prunes” the applications and registrations identified in blocks 220 and 230—applying the goods/services similarity scores and mark similarity scores generated as described above, and cutting out any that fall below certain pre-determined or dynamically assigned minimum levels (unless added back for meeting other criteria). In block 250, the component identifies marks with common ownership, and assigns a common color or style to all (or a subset of all) marks owned by the same entity. Users may be permitted to show, hide, or highlight marks owned by a specific owner or owners. In block 260, the component identifies the current application or registration status for identified marks using, for example, the techniques discussed in ¶¶[0041]-[0046]. In block 270, the component reports the results by, for example, generating a display (e.g., a dynamic display) of the results for the user, generating and storing a report for the user, allowing the user to annotate the report (e.g. highlighting or otherwise identifying particular marks or providing written comments), sending the results or a report of the results to the user, and so on. In this example, users may deselect certain goods and view results, which may result in re-weighted goods and services similarity scores, via the same methods. In block 280, the component creates a plot showing the relative risk posed by all non-pruned applications or registrations identified as potential risks by the facility.

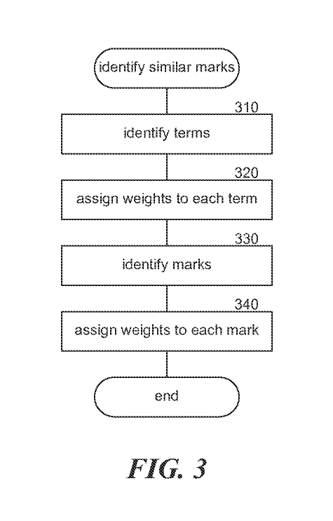

FIG. 3 is a block diagram illustrating the processing of an identify similar marks component of the facility in accordance with some embodiments of the disclosed technology. In block 310, the component determines whether the user-entered mark can and should be broken down into component tokens and then weights each tokens. In block 330, the component identifies similar marks. In block 340, the component assigns weights to each mark.

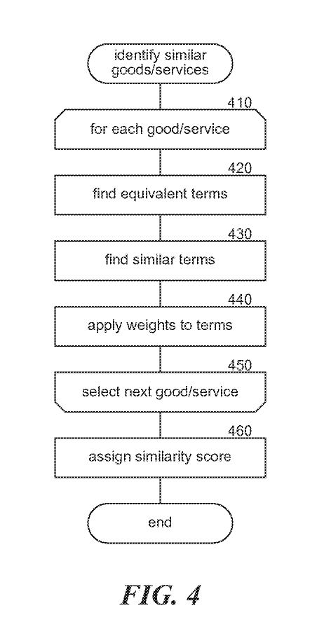

FIG. 4 is a block diagram showing the processing of an identifying and applying weights for each to good or service in each application or registration identified by the process show in FIG. 3, based on each user-entered good or service. In block 410, the component identifies goods and services that are similar to the first user-entered good or service, using, for example, the techniques described in ¶¶[0030]-[0040]. In block 420, the component identifies equivalent goods and services words or phrases. In block 430, identifies similar goods and services words or phrases. In block 440, the component applies weights to each identified goods and services words or phrases. This process may be performed, for example, in accordance with the process described in ¶¶[0030]-[0046]. In block 450, the facility selects the next user-entered good or service and loops back to block 410 to repeat the process for the selected user-entered good or service. In block 460, if multiple user-entered goods or services generate a similarity score for a good or service in a prior application or registration, the higher similarity score is assigned. This process may be performed, for example, in accordance with the process described in ¶¶[0030]-[0046].

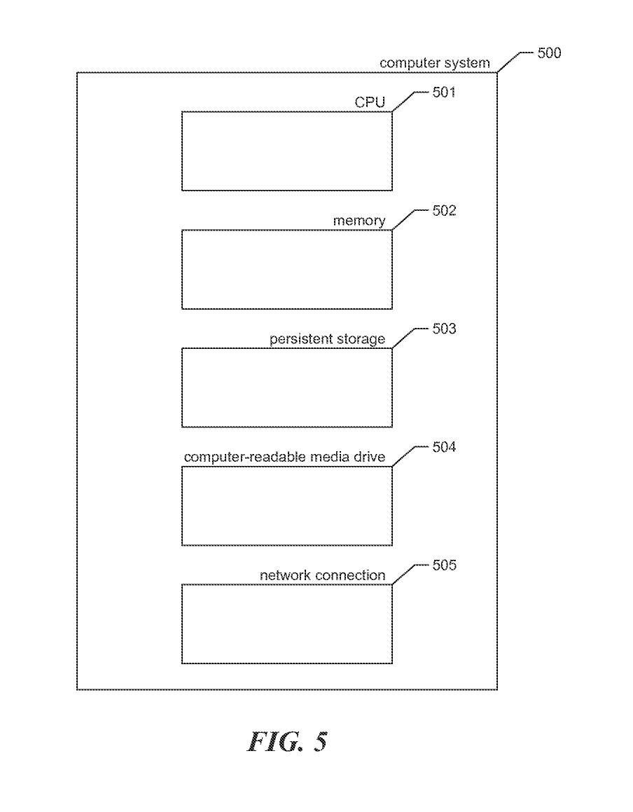

FIG. 5 is a block diagram illustrating some of the components that may be incorporated in at least some of the computer systems and other devices on which the system operates and with which the system interacts in some examples. In various examples, these computer systems and other devices 500 can include server computer systems, desktop computer systems, laptop computer systems, netbooks, tablets, mobile phones, personal digital assistants, televisions, cameras, automobile computers, electronic media players, and/or the like. In various examples, the computer systems and devices include one or more of each of the following: a central processing unit (“CPU”) 501 configured to execute computer programs; a computer memory 502 configured to store programs and data while they are being used, including a multithreaded program being tested, a debugger, the facility, an operating system including a kernel, and device drivers; a persistent storage device 503, such as a hard drive or flash drive configured to persistently store programs and data; a computer-readable storage media drive 504, such as a floppy, flash, CD-ROM, or DVD drive, configured to read programs and data stored on a computer-readable storage medium, such as a floppy disk, flash memory device, a CD-ROM, a DVD; and a network connection 505 configured to connect the computer system to other computer systems to send and/or receive data, such as via the Internet, a local area network, a wide area network, a point-to-point dial-up connection, a cell phone network, or another network and its networking hardware in various examples including routers, switches, and various types of transmitters, receivers, or computer-readable transmission media. While computer systems configured as described above may be used to support the operation of the facility, those skilled in the art will readily appreciate that the facility may be implemented using devices of various types and configurations, and having various components. Elements of the facility may be described in the general context of computer-executable instructions, such as program modules, executed by one or more computers or other devices. Generally, program modules include routines, programs, objects, components, data structures, and/or the like configured to perform particular tasks or implement particular abstract data types and may be encrypted. Moreover, the functionality of the program modules may be combined or distributed as desired in various examples. Moreover, display pages may be implemented in any of various ways, such as in C++ or as web pages in XML (Extensible Markup Language), HTML (HyperText Markup Language), JavaScript, AJAX (Asynchronous JavaScript and XML) techniques or any other scripts or methods of creating displayable data, such as the Wireless Access Protocol (“WAP”) or JSON (JavaScript Object Notation). Typically, the functionality of the program modules may be combined or distributed as desired in various embodiments, including cloud-based implementations.

The following discussion provides a brief, general description of a suitable computing environment in which the invention can be implemented. Although not required, aspects of the invention are described in the general context of computer-executable instructions, such as routines executed by a general-purpose data processing device, e.g., a server computer, wireless device or personal computer. Those skilled in the relevant art will appreciate that aspects of the invention can be practiced with other communications, data processing, or computer system configurations, including: Internet appliances, hand-held devices (including personal digital assistants (PDAs)), wearable computers, all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” “host,” “host system,” and the like are generally used interchangeably herein, and refer to any of the above devices and systems, as well as any data processor.

Aspects of the invention can be embodied in a special purpose computer or data processor that is specifically programmed, configured, or constructed to perform one or more of the computer-executable instructions explained in detail herein. While aspects of the invention, such as certain functions, are described as being performed exclusively on a single device, the invention can also be practiced in distributed environments where functions or modules are shared among disparate processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other computer-readable storage media. Alternatively, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Furthermore, the term computer-readable storage media does not encompass signals (e.g., propagating signals) or transitory media.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples; alternative implementations may employ differing values or ranges. Furthermore, although certain steps, functions, or functionalities may be described herein as being performed by or at a particular device, various steps, functions, functionalities, or portions thereof, may be performed at other devices. For example, display previews may be generated at a server or client device.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims. In some cases, various steps in the algorithms discussed herein may be added, altered, or removed without departing from the disclosed subject matter. Those skilled in the art will appreciate that features described above may be altered in a variety of ways. For example, the order of the logic may be rearranged, sublogic may be performed in parallel, illustrated logic may be omitted, other logic may be included, etc.

To reduce the number of claims, certain aspects of the invention are presented below in certain claim forms, but the applicant contemplates the various aspects of the invention in any number of claim forms. For example, while only one aspect of the invention is recited as a means-plus-function claim under 35 U.S.C. §112(f), other aspects may likewise be embodied as a means-plus-function claim, or in other forms, such as being embodied in a computer-readable medium. (Any claims intended to be treated under 35 U.S.C. §112(f) will begin with the words “means for,” but use of the term “for” in any other context is not intended to invoke treatment under 35 U.S.C. §112(f).) Accordingly, the applicant reserves the right to pursue additional claims after filing this application to pursue such additional claim forms, in either this application or in a continuing application.

1. A computer-readable storage medium storing instructions that, upon execution by a computing system having a memory and a processor, cause the computing system to perform a method for providing an automated mark clearance and/or watch notice service, the method comprising:
receiving information pertaining to marks and/or pending applications for registrations;
creating a goods/services list based at least in part on the received information pertaining to marks and/or pending applications for registrations;
parsing the goods/services list;
generating a stem list based at least in part on the parsed the goods/services list;
creating a good/services correlation table based at least in part on the parsed goods/services lists of active, use-based registrations and meta-registration records.

2. The computer-readable storage medium of claim 1, further comprising:
for each of a plurality of active, use-based registrations,
in response to identifying at least one registration with the same mark and owner as the active use-based registration,
combining the active, use-based registration and the identified at least one registration with the same mark and owner into a meta-registration record.

3. The method of claim 1, further comprising:
identifying tokens of a first mark;
for each identified token of the first mark,
assigning a weight to the token.

4. The method of claim 3, further comprising:
receiving a user-entered description of goods or services,
wherein assigning a weight to a token for each international class identified as a primary class for the user-entered description of services comprises:
in response to determining that the token appears in the user-entered description of goods or services,
calculating a first score for the token,
in response to determining that the token appears in goods or services descriptions of trademark applications or trademark registrations in the same class as at least one user-identified good or service,
calculating a second score for the token,
in response to determining that the token is disclaimed in registrations or applications in the same class as the at least one user-identified good or service,
calculating a third score for the token,
in response to determining that the token is in prior registrations on a non-primary register in the same class as the at least one user-identified good or service,
calculating a fourth score for the token, and
in response to determining that the token appears in registrations owned by a number of different owners in the same class as the at least one user-identified good or service,
calculating a fifth score for the token,
calculating a weight for the token based at least in part on each of the calculated scores.

5. A method, performed by computing system having a memory and a processor, the method comprising:
identifying at least one mark and at least one good or service based at least in part on input received from a user;
identifying tokens of the at least one mark;
identifying a set of trademark applications or trademark registrations with marks similar to the identified at least one mark or the identified tokens of the at least one mark;
for each of the identified tokens of the at least one mark,
calculating a strength of the identified token of the at least one mark;
for each trademark application and trademark registration in the set of trademark applications or trademark registrations,
scoring mark similarity for the trademark application or registration based at least in part on the calculated strengths of the identified tokens of the at least one mark and tokens of the trademark application or registration;
from among the set of trademark applications or trademark registrations, identifying a first set of trademark applications or trademark registrations with goods or services similar to at least one user-identified good or service;
from among the set of trademark applications or trademark registrations, identifying a second set of trademark applications or trademark registrations with international classes associated with at least one user-identified good or service;
for each trademark application and trademark registration in either the first or second set of trademark applications or trademark registrations,
scoring goods or services similarity based on class similarity and/or goods or services similarity, and
scoring overall similarity by combining mark similarity and goods or services similarity scores for the trademark application or trademark registration;
for each identified registered mark or pending application similar to the identified at least one mark,
identifying registered marks or pending applications similar to the identified at least one mark and having an owner in common with an owner of at least one other identified registered mark or pending application similar to the identified at least one mark,
determining an application status for each identified registered mark or pending application similar to the identified at least one mark or pending application; and
plotting at least a portion of the identified registered marks or pending applications similar to the identified at least one mark, reflecting common ownership and status.

6. The method of claim 5, wherein identifying at least one mark and at least one good or service based at least in part on input received from a user comprises identifying the at least one mark and at least one good or service through direct entry.

7. The method of claim 5, wherein identifying at least one mark and at least one good or service based at least in part on input received from a user comprises identifying an application number or registration number.

8. The method of claim 5, further comprising:
determining tokens of a user-entered mark and marks in applications and registrations by comparing the user-entered mark or marks or tokens thereof with existing corpuses of data.

9. The method of claim 8, further comprising:
determining tokens of a user-entered mark and marks in applications and registrations at least in part by:
comparing the user-entered mark or marks or tokens thereof against set of set of text strings and patterns that identify features: times of day, seasons, numbers, emoticons, and domain names,
comparing the user-entered mark or marks or tokens thereof against a list of words,
comparing the user-entered mark or marks or tokens thereof against a frequency-weighted list of words.

10. The method of claim 5, wherein identifying the set of trademark applications or trademark registrations comprises:
identifying at least one registration that includes a mark identical to the at least one mark or that includes a token identical to at least one identified token of the at least one mark.

11. The method of claim 5, wherein identifying the set of trademark applications or trademark registrations comprises:
identifying at least one registration that includes a mark comprising at least one token phonetically identical or phonetically similar to the at least one mark or an identified token of the at least one mark.

12. The method of claim 5, wherein identifying the set of trademark applications or trademark registrations comprises:
identifying at least one registration that includes a mark comprising at least one token of the at least one mark.

13. The method of claim 12, wherein the at least one token is a stemmed token.

14. The method of claim 5, wherein identifying the set of trademark applications or trademark registrations comprises:
employing a plurality of search strategies,
for each of the employed search strategies,
retrieving a plurality of search results, each search result comprising a trademark application or trademark registration,
for each of the retrieved plurality of search results, dynamically assigning a weight to a trademark application or trademark registration in the search results based at least in part on the search strategy, strategies, or combination of strategies that retrieved that given application or registration.

15. The method of claim 5, wherein scoring goods and services similarity of trademark applications or trademark registrations comprises:
receiving a user-entered description of goods or services;
identifying a probable international class of the user-entered description of goods or services;
identifying a set of coordinated classes associated with the identified probable international class;
for each of the trademark applications or trademark registrations in the set of trademark applications or trademark registrations that contain similar marks or tokens,
identifying shared or related goods and services strings within the trademark application or trademark registration,
identifying international classes of the trademark application or trademark registration that are identical to the identified probable international class of the user-entered description of goods or services,
identifying coordinated international classes to the identified probable international class of the user-entered description of goods or services based upon a list of coordinated classes,
for each trademark application or trademark registration containing either shared or related goods or services strings,
assigning a goods and services score based on the extent of class overlap, coordinated class relationship, and goods-services similarity overlap, and
assigning a mark similarity score to the trademark application or trademark registration based at least in part on:
the number of identified tokens of the trademark application or trademark registration, and
the weight assigned to each search strategy that identified the trademark application or trademark registration.

16. A computing system, comprising:
a processor;
a memory;
a component configured to receive information pertaining to marks and/or pending applications for registrations;
a component configured to create a goods/services list based at least in part on the received information pertaining to marks and/or pending applications for registrations;
a component configured to parse the goods/services list;
a component configured to generate a stem list based at least in part on the parsed the goods/services list;
a component configured to create a good/services correlation table based at least in part on the parsed goods/services lists of active, use-based registrations and meta-registration records.
a component configured to identify at least one mark and at least one good or service based at least in part on input received from a user;
a component configured to identify tokens of the at least one mark;
a component configured to identify a set of trademark applications or trademark registrations with marks similar to the identified at least one mark or the identified tokens of the at least one mark;
a component configured to, for each of the identified tokens of the at least one mark,
calculate a strength of the identified token of the at least one mark;
a component configured to, for each trademark application and trademark registration in the set of trademark applications or trademark registrations,
score mark similarity for the trademark application or registration based at least in part on the calculated strengths of the identified tokens of the at least one mark and tokens of the trademark application or registration;
a component configured to, from among the set of trademark applications or trademark registrations, identify a first set of trademark applications or trademark registrations with goods or services similar to at least one user-identified good or service;
a component configured to, from among the set of trademark applications or trademark registrations, identify a second set of trademark applications or trademark registrations with international classes associated with at least one user-identified good or service;
a component configured to, for each trademark application and trademark registration in either the first or second set of trademark applications or trademark registrations,
score goods or services similarity based on class similarity and/or goods or services similarity, and
score overall similarity by combining mark similarity and goods or services similarity scores for the trademark application or trademark registration;
a component configured to, for each identified registered mark or pending application similar to the identified at least one mark,
identify registered marks or pending applications similar to the identified at least one mark and having an owner in common with an owner of at least one other identified registered mark or pending application similar to the identified at least one mark,
determine an application status for each identified registered mark or pending application similar to the identified at least one mark or pending application;
a component configured to, plot at least a portion of the identified registered marks or pending applications similar to the identified at least one mark, reflecting common ownership and status; and
a component configured to highlight at least one most-related good or service word or phrase in a summary of results,
wherein each component comprises computer-executable instructions stored in the memory for execution by the computing system.
